(19) United States
(12) Patent Application Publication
(10) Pub. No.: US 2009/0104591 A1
(43) Pub. Date: Apr. 23, 2009

(54) SYSTEM AND METHOD FOR LEARNING ENHANCEMENT BASED ON A SPORTS GAME

(76) Inventor: Joseph Panetta, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/254,914

(22) Filed: Oct. 21, 2008

Related U.S. Application Data
(60) Provisional application No. 60/981,730, filed on Oct. 22, 2007.

(51) Int. Cl. G09B 7/00

(52) U.S. Cl. 434/350; 434/322; 434/362

(57) ABSTRACT

A method of practicing educational exercises in the context of a simulated professional competitive sports game. The method includes assembling teams of students to compete against each other in the competitive sports game. Questions are posed to students during play of the sport and the correctness and time of response determines play outcome in the sport. Students have opportunities to make strategy decisions within the sports game context and such strategy decisions can result in harder or easier questions being posed depending on the potential reward of playing one strategy over another. The disclosure is based on baseball as the competitive background, while performing similar exercises in the context of other sports is equally possible.

### CROSS-REFERENCE TO RELATED APPLICATIONS

This utility application claims the benefit under 35 U.S.C. §119(e) of Provisional Application Ser. No. 60/981,730 filed on Oct. 22, 2007 and entitled System and Method for Learning Enhancement Based on a Sports Game, the entire disclosure of which is incorporated by reference herein.

### FIELD OF INVENTION

This invention relates to field of learning aids. More specifically, this invention relates to question-and-answer-based learning aids that use a competitive sport as a basis for answering questions

### BACKGROUND OF THE INVENTION

Education in fundamental subjects such as mathematics and science has historically taken many forms. One learning aid commonly used is the question and answer format. Responding to a specific question and having to work the answer out under time pressure is a well-practiced method that enhances learning in most students. Moreover, as testing is a reality of most methods of education, question and answer drills also assist the student in being able to cope in a time-pressure testing environment. Inevitably, students at the elementary level and, sometimes, later grades, lose interest before they have fully grasped what they set out to learn. It is important to keep the student's excitement level high and bring new angles to their studies. This is especially so in an age that is rife with distractions such as electronic games, music, the Internet, fashion and television, not to mention challenging family situations that can overwhelm a young student's ability to concentrate on study.

Competitive exercises are one way to engage a student's attention. The most common is perhaps the spelling bee. As teachers are always interested in new ways to engage their students and foster enthusiasm for learning, a need exists for new means of posing questions in a competitive setting. The inventor has designed a method of posing questions as learning aids in a novel fashion that pits teams of students against each other in a competitive sports setting. The disclosed example involves posing questions in the format of the game of baseball and can take several forms: an interactive computer program with teams competing over the internet or like means; a classroom activity conducted in person with spoken or projected questions where game play is followed on a black board or other large visual device; and a television game show.

### BRIEF SUMMARY OF THE INVENTION

In an embodiment of the invention, there is an interactive, computer driven, mathematics teaching aide, designed to be played by elementary age students (5th through 8th grade) or higher. This game involves a competition, similar to a baseball game, played by two teams of students, with a maximum of seven players per team, wherein play advances based on the students' answers to math questions selected by a teacher. The game further allows the players to select strategic playing options, such as walking a batter, hitting a sacrifice fly and swapping in a pinch hitter. Question difficulty varies depending on student grade level, student selection of play options (more difficult questions reap greater offensive or defensive gains) and game sequence (more difficult questions posed as the game progresses).

### BRIEF DESCRIPTION OF SEVERAL VIEWS OF THE DRAWINGS

The invention will be described in conjunction with the following drawings in which like reference numerals designate like elements and wherein:

FIG. 1 is a block diagram of exemplary databases to implement a competitive learning aid;

FIG. 2 is an exemplary computer screen accessible only to teachers;

FIG. 3 is a further exemplary computer screen accessible only to teachers;

FIG. 4. is a further exemplary computer screen accessible only to teachers for setting up teams;

FIG. 5. is a further exemplary computer screen accessible only to teachers for accessing student statistics;

FIG. 6. is a further exemplary computer screen accessible only to teachers showing student statistics;

FIG. 7. is an exemplary initial computer screen accessible by student players;

FIG. 8. is a further exemplary computer screen accessible by student players showing league statistics;

FIG. 9. is a further exemplary computer screen accessible by student players for a team at bat;

FIG. 10. is a further exemplary computer screen accessible by student players for a team in the field;

FIG. 11. is a further exemplary computer screen accessible by student players when a hint is requested from the coach;

FIG. 12. is a further exemplary computer screen accessible by student players and displayed to the team at bat after a question is posed;

FIG. 13. is a further exemplary computer screen accessible by student players, and displayed to the team in the field after the question is posed;

FIG. 14. is a further exemplary computer screen accessible by student players after the answer to the question is revealed; and

FIG. 15. is a further exemplary computer screen that is displayed when a student clicks the “email the teacher” area on the screen shown in FIG. 14.

### DETAILED DESCRIPTION OF THE INVENTION

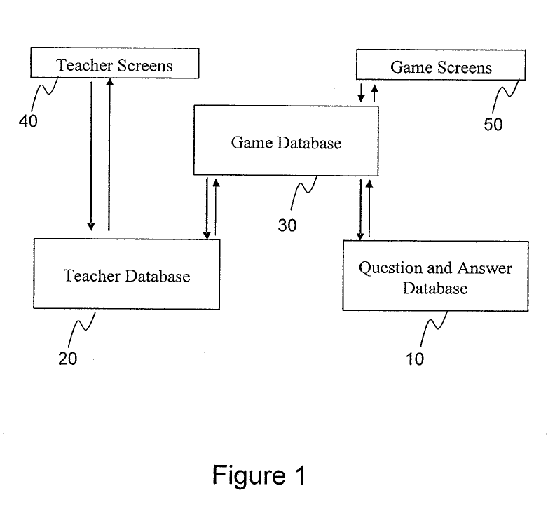

In an embodiment of the invention, questions are posed to competing teams of students who compete against each other in a baseball game format. Playing the game requires at least two linked computers, one per team. The game is composed of three major parts depicted in FIG. 1: a question and answer (Q&A) database 10, containing questions and answers that are the source material for the game; a teacher database 20, for use by the teacher only, for set up and for storing all the pertinent statistics of each player and which contains teacher screens 40 for teacher input and data access; and a game logic database 30, containing the game logic and playing screens 50.

The Q&A database 10 contains a series of questions, all multiple-choice, offering four choices to the players: A, B, C or D. This database is pre-populated by the manufacturer and is designed to accept the questions, both numeric and word problems and the answers. The questions are arrayed by module: multiplication, adding, subtracting, dividing, fractions, decimals, etc. and by difficulty within each module. The difficulty level is grouped in ascending order: 1 through 7. In other words, the Q&A database contains approximately 10 questions, of each level, for each module. These questions are used in the Single A and Double A versions of the game. A series of more difficult questions, arrayed as detailed above, are used for the Triple A and Major League version of the exercise.

The teacher database is the entry point for teachers to create teams and form Mathball USA leagues and it stores all the data for each student, for each individual Q&A module and throughout the game season: number of questions answered correctly by level of difficulty, number answered correctly and faster than the opposing player by level of difficulty, number of steal attempts and successes, number of pick-off attempts and successes, number of walks, etc. The statistics are similar in flavor to those kept by major league baseball but relative to the students' mathematics ability and confidence level.

To begin use the teacher, via user screens, accesses the statistics database and establishes teams of students: team name, student name, and jersey number for student (one through seven). The program assigns each student a user identification number. The students must use this user ID number to play the game and this will link the student to his/her statistics, to be viewed by the teacher.

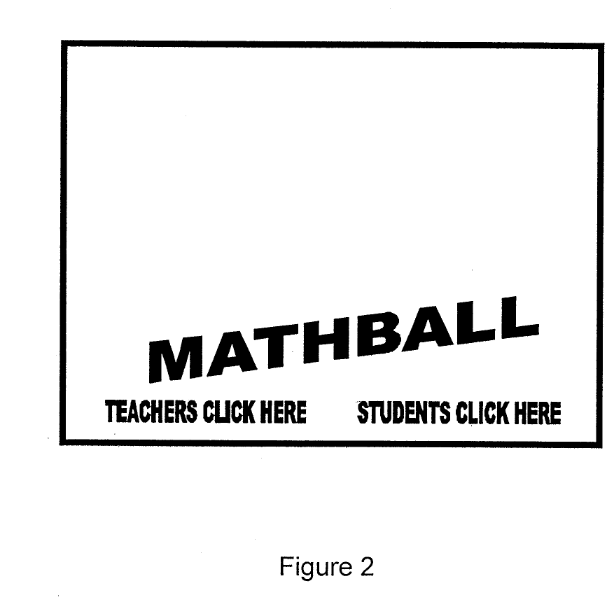

The exemplary teacher slides, FIGS. 2-6 offer an example of the kinds of user screens used in the “teacher section.” The slides depicted are simple wireframes but exciting graphics, including licensed Major League Baseball images can be included on all screens described herein.

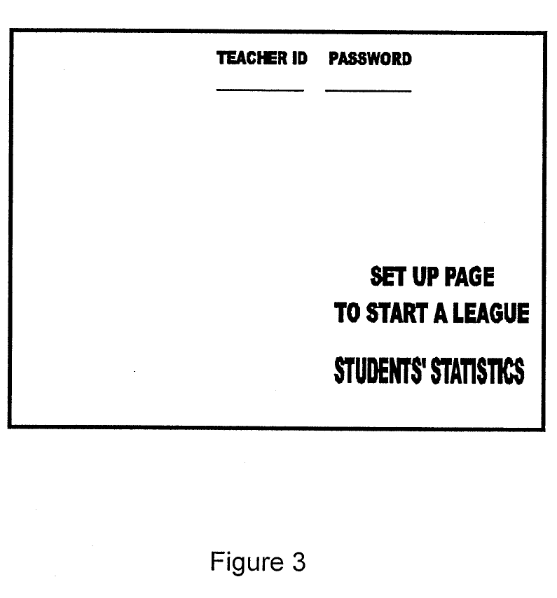

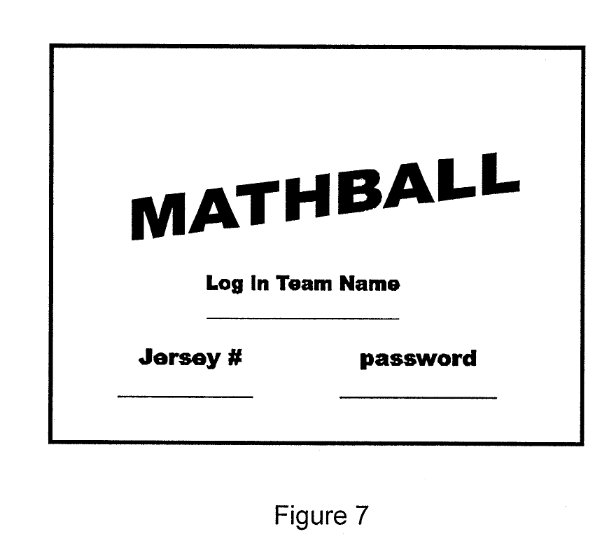

FIG. 2 is an exemplary opening screen—click and enter MATHBALL. Teachers go to setup/stats page (FIG. 3). Students go to the game page (FIG. 7).

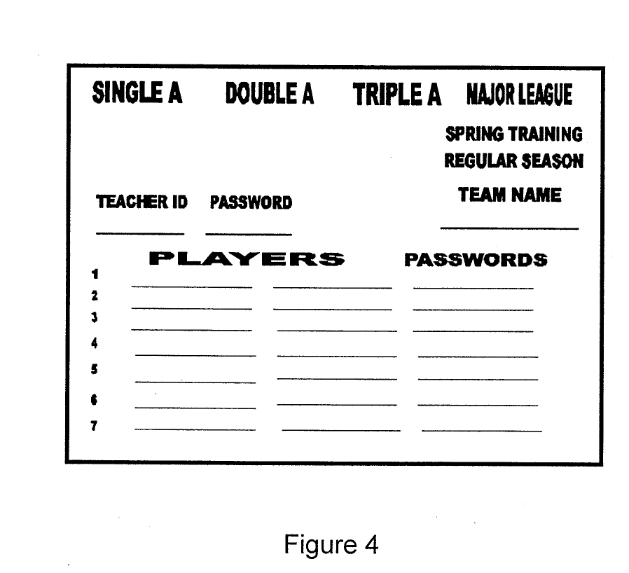

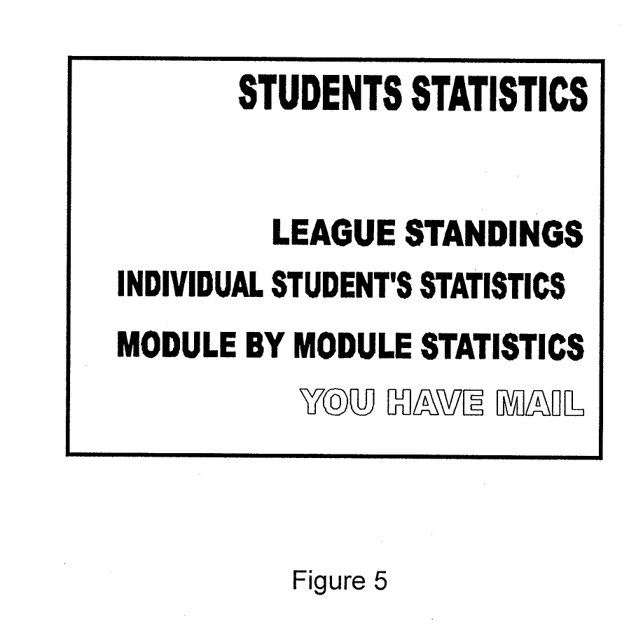

FIG. 2 is an exemplary teacher only page—Teacher chooses to start a league through the set up page (FIG. 4) or get stats on their students (FIG. 5).

FIG. 4 is an exemplary teacher setup page—Teacher chooses the playing level, and requests spring training or regular season, then enters team name and players (teacher will decide number of players per team)—MATHBALL will start to form the league. Spring training will have a max of 4 games but the teacher can opt for regular season before all 4 games are finished.

FIG. 5 is an exemplary teacher statistics page, where the teacher can get information on student's game by game, highlight strengths and weaknesses, find out if a particular math module needs to be re-taught, etc.

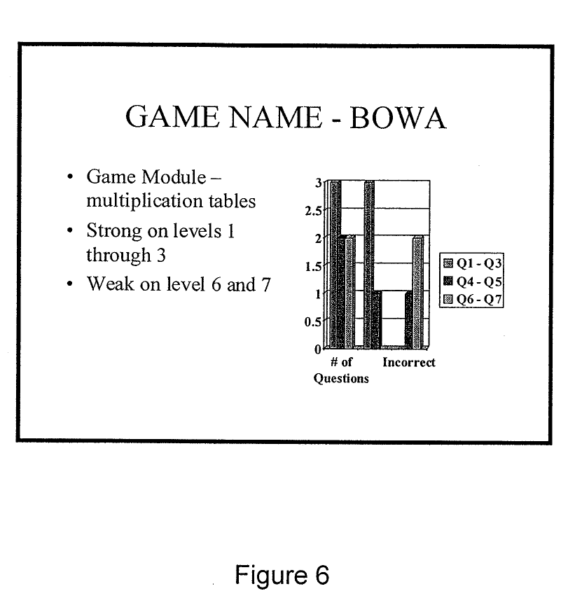

FIG. 6 is an exemplary screen for student's game statistics for a typical module

The game database contains the baseball-like logic behind this math game. Both students and teachers can access the game database. The game slides, FIGS. 7-15 offer an example of the kinds of user screens envisioned for the “game section.” See, Appendix 1 incorporated herein, which is a spreadsheet form of the game logic for each of the four levels.

As shown in the exemplary screen in FIG. 7, after the teacher sets up a competition, each player logs in with their password and they go directly to the next game in the season. On the initial set up screen, the number of players per team were decided. If this is a seven player league, seven players must log in, for a five player league, five must log in.

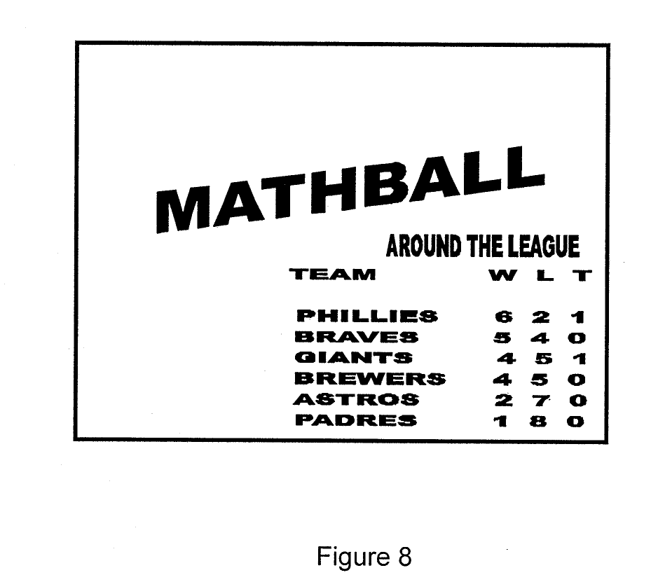

As shown in the exemplary screen in FIG. 8, after both teams have logged in, a league standings page is shown. A similar page can pop up, between innings, etc. to show up to the minute stats on games around the league.

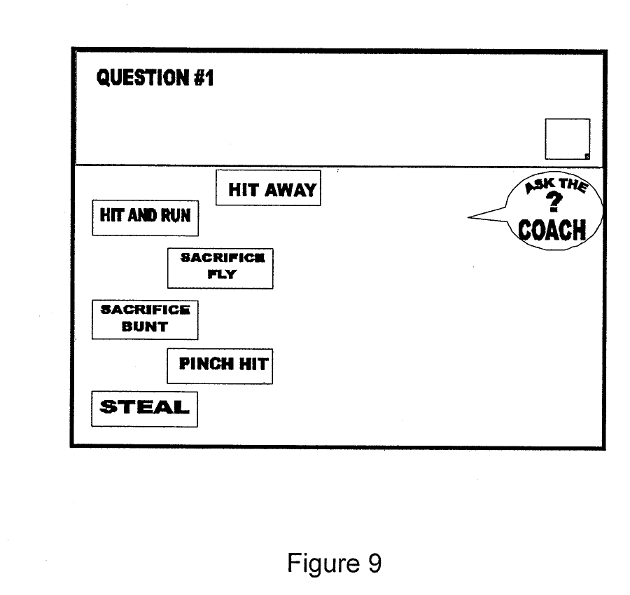

FIG. 9 is an exemplary TEAM AT BAT screen. Questions appear on the upper board, simultaneously for both teams, once a decision has been made on strategy (the coach button hints are only seen by the team asking for help). Upper right hand side square highlights men on base, etc. Offense gets 15 seconds to choose a strategy with an additional 10 if a coach's hint is requested. Only one coach's hint per team per half-inning. After that, Mathball swings into a question (HIT AWAY).

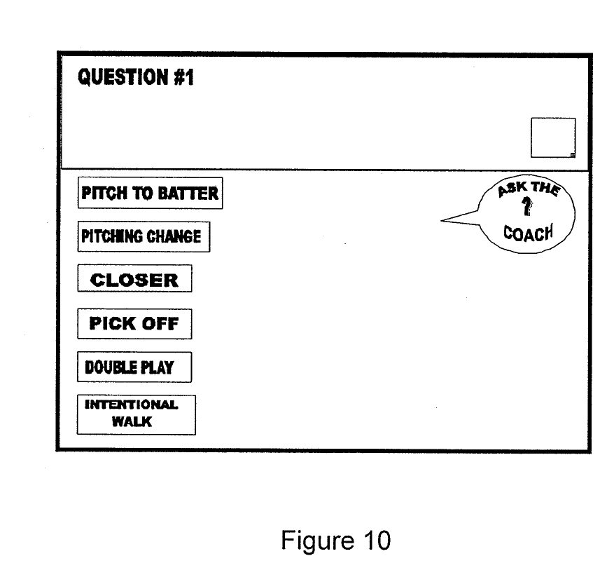

FIG. 10 is an exemplary TEAM IN THE FIELD screen. Questions appear on the upper board, simultaneously for both teams, once a decision has been made on strategy (the coach button hints are only seen by the team asking for help). Upper right hand side square highlights men on base, etc. Defense gets 15 seconds to choose a strategy (other than pitching change) with an additional 10 if a coach's hint is requested. Only one coach's hint per team per half-inning. After that, Mathball swings into a question (HIT AWAY). Only the pitching change is active, after the question appears but the defense must choose this before the batter “swings” an answer.

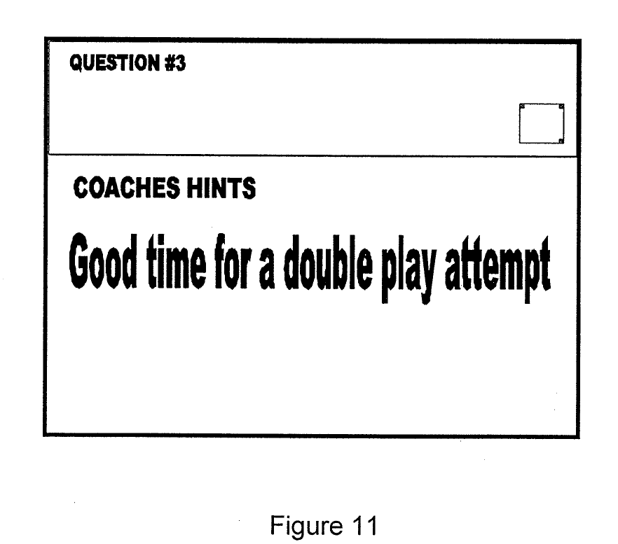

FIG. 11 is an example of a screen with a coach's corner hint (defense asked the coach for a hint).

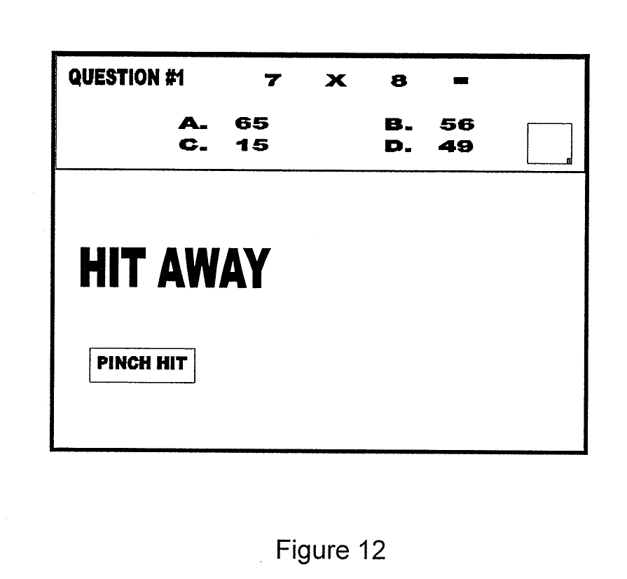

FIG. 12 is an exemplary TEAM AT BAT screen. Questions appear on the green board, simultaneously for both teams, once a decision has been made on strategy and/or coaches hints. Upper right hand side square highlights men on base, etc. Here the batter has chosen to hit away. If they haven't yet used their pinch hit options, the pinch hit can bring in a replacement question.

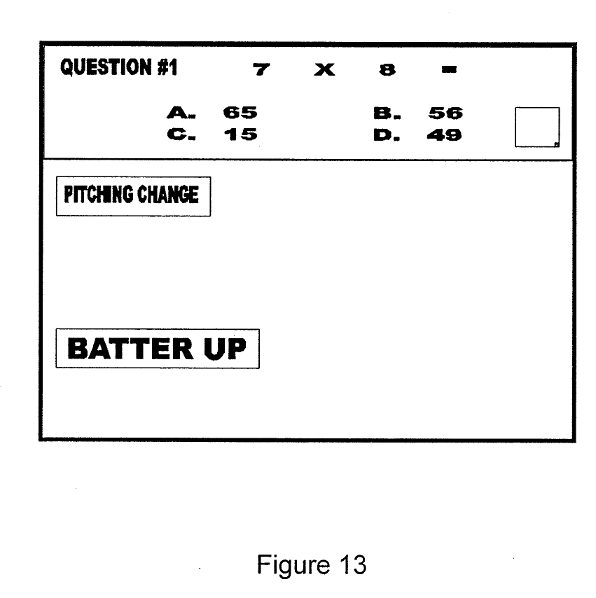

FIG. 13 is an exemplary TEAM IN THE FIELD screen. Questions appear on the green board, simultaneously for both teams, once a decision has been made on strategy and/or coach's hints. Upper right hand side ellow square highlights men on base, etc. If they haven't yet used their pitching change options, the pitching change can call up a replacement question.

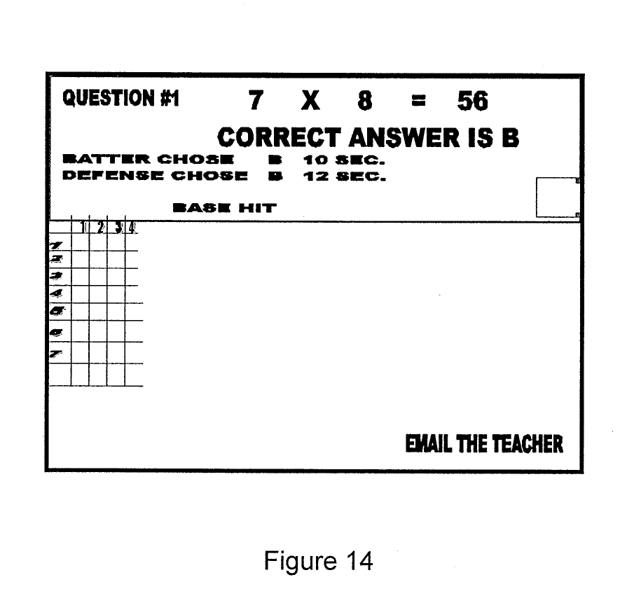

FIG. 14 shows an exemplary screen wherein both teams have locked in their answers. Mathball waits for both teams to lock their answers or 30 seconds, whichever comes first. Speed will count at all levels beyond Single A. Now Mathball will reveal the results to both teams, including a scorecard throughout the game. EMAIL THE TEACHER produces a screen that emails a question to the teacher

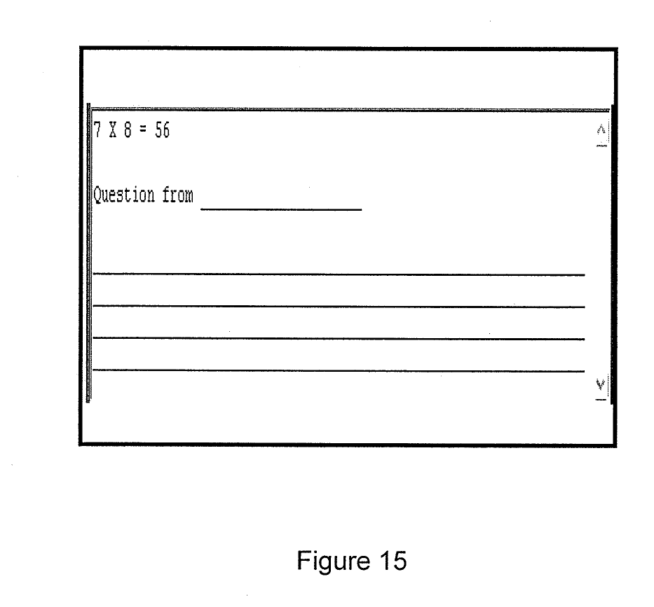

FIG. 15 is an exemplary screen to email the teacher. Click the EMAIL TO TEACHER block and this screen will appear, showing the question at hand and allowing a quick note from the student, who types in his game name and question.

Once students are registered, the teacher determines which module to play and teams begin by answering questions. Questions are selected automatically by the computer program. Questions are specific to a learning level module and with each module, specific questions are assigned to difficulty levels. At each difficulty level within a module, a set of questions is available. The questions at each difficulty level are presented in the order stored, or in any other predetermined order, or can be presented in a random fashion with provisions to avoid repetition of questions during a game. Player #1, for both teams, answers question #1, Player #2 answers question #2, player #3 answers question #3, etc., until 7 questions are answered or 3 outs are recorded. For the next inning, the next player up answers the #1 question. Any player in the order could become the leadoff hitter and any fielder could see the first question hit his/her way, in a given inning, just like a real baseball game. Each two opposing players (#1 vs. #1, #2 vs. #2, etc.), for each team, answer the same question, simultaneously, from their respective computers.

The game instructions are easy and teachers will have no difficulty setting up the leagues. Teachers assign students to teams and give each student player a jersey number, one through seven. The teacher then assigns the Math modules, to be “played”, and play commences.

The premise is simple. Students answer the questions correctly, make hits and score runs. Correctness and speed are a must, with the emphasis on being correct. In an exemplary embodiment, a series of seven questions are posed each inning, each progressively harder, each in perfect compliment with the teaching syllabus.

Competition starts off at the basic, Single A, level. As the students get a “feel” for the game, the program will elevate them to Double A, Triple A and, finally, the “Big League”, Major League level.

Each season will start with a few warm up games and, then, off to the regular season. Teams/players vie to make the playoffs and win the World Series of Math. A typical class schedule would be:

November-December—spring training (pre-season games are like the real thing but answers are prompted)

January-April—regular season (games can end in a tie, 2 points per win, one per tie)

May—playoffs and World Series (can involve up to extra innings and then tie-breaker questions, unused game questions, easiest to hardest)

1. The competition can involve one school or several schools competing against each other; individuals or teams.

2. Competition is within each grade: leagues for 5th, 6th, 7th, 8th grades and high school.

3. Object is to win games and be one of the top teams (these teams make the playoffs).

4. Schedule comprises of an equal number of home and away games, one game every week (approximately twelve regular season games).

5. Each game has three innings, each inning has a maximum seven question at bat for each team.

6. Games can be played one-on-one or in teams, with a maximum of seven players.

7. For team play, players are assigned a “jersey number” one through seven. This number will remain the same throughout the season. The game is played like a baseball game.

a. Player #1, for both teams, answers question #1, Player #2 answers question #2, player #3 answers question #3, etc., until 7 questions are answered or three outs are recorded. For the next inning, the next player up answers the #1 question. Any player in the order could become the leadoff hitter and any fielder could see the first question hit his/her way, in a given inning, just like a real baseball game.

8. Math questions are geared to the specific grade and are arrayed in topics, no one sees the questions ahead of time but the teacher picks the topics (pre-season competition gives each team a feel for the game).

### Single A Game

In an exemplary embodiment of a “Single A” level game, a 30 second clock limits each team but each team gets all 30 seconds to answer. Runs can only score on a hit (correct answer). At the teacher's discretion the game answer clock can be extended to 35, 40 or 45 seconds to give each student a chance to play, succeed and acclimate to the game.

1. The object is to score a maximum number of runs. Runs are scored by answering as many questions correctly before making three outs. The questions become consecutively harder (#1 is the easiest, #7 the hardest, in a given inning).

2. Each team attempts to answer the question (team at bat and team in the field), batters are safe when they answer correctly. Batters are out when they answer incorrectly and the defense answers correctly, or fail to answer within the time limit.

a. For the first four batters, correct answers result in singles. The batter is safe at 1st and runners advance when forced. Runners do not advance on outs

b. For the fifth batter, a correct answer results in a double and the batter is safe at second. Runners on second and third can score. Runners do not advance on outs

c. For the sixth batter, a correct answer results in a triple and the batter is safe at third. Runners on any base can score. Runners do not advance on outs.

d. For the seventh batter, a correct answer results in a homerun. All runners and the batter score. Runners do not advance on outs. Getting all seven answers correct will score seven runs. The inning is over after the seventh question.

e. If the batter fails to answer in the allotted time, he strikes out and no runs can score.

f. If both teams fail to answer, or both teams answer incorrectly, it is a foul ball and a new question is posed.

### Double A Game

An exemplary “Double A” level game adds real baseball game atmosphere. There is still a 30 second clock but getting the answer correct isn't enough. The players need to be quick, too. Here, again, at the teacher's discretion, the clock can be extended to 35 or 40 seconds.

1. Previous Single A rules apply with the following changes:

2. If the batter answers first and correctly, he's safe, but, if the defense answers first and correctly, he's out.

3. If the defense, answers first and incorrectly, and the offense answers correctly, it's a one base error. The batter and all runners advance one base further than normal, according to the basic rules.

### Triple A and Major League Games

In more advanced exemplary games, termed, for example, Triple A and Major League games, game strategy of real baseball games is incorporated. The strategy plays allow the offense to maximize scoring chances and the defense to play around tough batters. At these levels, the answer clock is locked at 30 seconds maximum.

1. The Double A rules apply with the following changes and additions:

2. Each team gets 2 pinch hits per game to skip a question. This allows a “Strategy play”. If the batter is unsure of his answer, the team can “pinch hit” a new question of the same level, before choosing to answer. This will result in a new question, same batter (answer time minus 2 sec.). The batter gets a 2 second advantage to answer the question. The batter has 15 seconds, after the question is posed, to decide to pinch hit.

3. Each team can make 2 pitching changes per game to skip a question. This allows further “Strategy plays.” If the team in the field thinks the batter will get the answer right, they can make a pitching change for a new question of the same level before choosing to answer. The defense gets a 2 second advantage to answer the question (answer time minus 2 sec.). The batter has 15 seconds, after the question is posed, to decide whether to pinch hit. As a special pitching change, a Closer can enter the game for the defensive team. This results in the toughest questions (#7 level) for the first 3 batters of the inning, limit: 1 per team (this counts as a pitching change, including a 2 second advantage, for the defense, while facing the first 3 batters) and the closer (defender answering the question) is not penalized for a wrong answer first. If the batter is correct first, within 10 seconds, it is a homerun; within 20 seconds, it is a double, between 20 and 30 seconds, it is a single. If the closer does not record 3 outs through the first 3 batters, the 4th batter will attempt to “hit” a #4 level question, etc. and the defense gets no time advantage.

4. An intentional walk can be elected by defense, to skip a batter, limit: twice per team per game. No inning can end on an intentional walk (the 7th batter in an inning cannot be walked). The “Strategy play” here is To skip a batter that is consistently answering quick and correct. It's like pitching around the other teams “big” hitter.

5. The batter can sacrifice fly, limit twice per team per game. The batter will be asked a question that is one level lower than normal, regardless of where he is in the batting order. Answering first and correctly will result in an out but runners could advance one base. The “Strategy play” here is that runners can advance without a hit. When there are runners on base, if the batter answers first and correctly, within 15 seconds, he is out but a runner on third scores and other runners move up one base. If he answers first and correctly within 16 to 30 seconds, he is out. No runs can score but runners can move up one base, if the base is not occupied. If the defense answers first and correctly, the batter is out and runners cannot advance. This is useful in situations where one run can win the game, e.g., bottom of the last inning or to put the game out of reach with an 8th run before the other team's last at bat. The sacrifice can help a player “play within his or her math ability” and still contribute positively to the team.

6. When there is a runner on 1st, with 2nd and 3rd base unoccupied, the team at bat can call a “hit and run”. The batter must answer a question that is one level higher than normal. The “Strategy play” here is that a runner can advance more than one base on a single. If the batter answers first and correctly, within 15 seconds, the batter is safe at first and the runner on 1st moves up two bases to 3rd. If he answers first and correctly within 16 to 30 seconds, the batter is safe at first and the runner move up one base to 2nd. If the defense answers first and correctly, within 15 seconds, the runner on 1st is out and the batter is safe at first (force at 2nd, fielder's choice). If the defense answers first and correctly within 16 to 30 seconds, the batter is out and the runner does not advance. Players, batting second or third in an inning can show math confidence and get their team on a “roll” by putting a runner in scoring position.

7. A double play can be attempted by defense by answering a question that is one level higher than normal, whenever there is a runner on 1st, limit twice per team per game. The “Strategy play” here is that the defense can record two outs on one question. If the defense answers first and correctly, both the runner on 1st and the batter are out. If the batter answers correctly first, he is safe and the batting rules for the question level apply. Double plays can be attempted against batters 2 through 6, since batter #7 will end the inning. This can stop a “big inning” by the batting team.

A sacrifice bunt can be elected by offense, to defeat a double-play attempt, limit one per team per game. The batter will be asked a question according to the normal batting order rules. If the batter answers correctly first, within 15 seconds, the batter is out but all runners advance one base. Otherwise, if the batter answers correctly first, he's out and the runners cannot advance. However, if the defense answers first correctly, within 15 seconds, they still complete the double play. Otherwise, the batter is out and the runners do not advance. This can help a player “play within his or her math ability” and still contribute positively to the team.

8. The team at bat can try to steal an unoccupied base by answering an additional question, based on the base to be stolen. The “Strategy play” here is that runners can advance one base. The runner, who wants to steal, must answer a #5 level question to steal 2nd, a #6 level question to steal 3rd, or a #7 level question to steal home. The runner must answer first and correctly, or he is out. If both teams answer incorrectly, the runner is safe at the original base. After the steal attempt, the batter steps up for the next question. Only one steal attempt per runner per inning. Players can show math confidence and get their team on a “roll” by putting a runner in scoring position.

9. Pickoff can be elected by defense before question. The “Strategy play” here is that the defense can eliminate a base runner. The defense must answer a #5 level question to pickoff a runner on 1st, a #6 level question to pickoff a runner on 2nd, or a #7 level question to pickoff a runner on 3rd. Defense must answer right first, to get the selected runner out or a balk is called and all runners advance one base, if the runner answers first and correctly. If both teams answer incorrectly, the runner is safe at the original base. After the pickoff attempt, the batter steps up for the next question. Only one pickoff attempt per inning.

### Board Game

In a further embodiment, the play is not performed on a computer but in a live classroom setting with competing players in the same room as a teacher. An exemplary board game comprises the following elements:

1. Overhead projection question transparencies (20 lesson packets, each with 7 transparencies: 6 with 1st, 2nd and 3rd inning questions (two of each), 1 with special play questions)

2. 2 Cover cards for transparencies

3. Folding baseball-like field with marker and eraser

4. Scorer's flip cards, numbered 0 to 21

5. Adjustable timer with buzzer

6. Students' answer cards, letters A, B, C and D (7 blue sets, 7 red sets)

7. Score sheets

8. Selection spinner

Board Game Preparation

1. In an exemplary board game embodiment, the game can be played with up to seven players per team but the number must be the same for both teams. The players are arranged across the room, the Blue team to the left, and the Red team to the right. Each player has a number going left to right; Blue team 1, 2, 3, 4, 5, 6, and 7 and Red team 1, 2, 3, 4, 5, 6, and 7.

2. Each student is given a set of student answer cards, blue for the Blue team, and red for the Red team.

3. The baseball field is attached to the blackboard or wall.

4. The overhead projector is set up and adjusted.

5. The lesson packet to be played is selected and opened.

6. The 1st inning card is selected, slipped it into the cover card and placed on the overhead. Each inning card has seven questions, each progressively harder. The game is designed to have the students answer question #1 then #2, then #3, etc. The special play card has ten questions, all level five difficulty.

7. Each team gets its time at bat and time in the field each inning. In other words, each team will answer at least two sets of inning one questions, two sets of inning two questions and two sets of inning three questions.

8. The teacher decides the number of seconds to allow for each answer and set the timer. A recommended starting time is thirty seconds, which can be adjusted as required, per game.

9. A student, not playing on a team, is selected as scorekeeper, perhaps the MVP from the previous game. The scorekeeper will keep track of the “men on base” and record the “game statistics, using the score sheets.

10. The Blue team bats first and the Red team is in the field first.

11. Each team bats in each inning (the Red team has “last bats”). The team at bat tries to get hits and score runs, while the team in the field tries to get them out.

12. The team with the most runs scored, at the end of 3 innings, wins the game. In case of a tie score, winners are decided by tie breakers:

a. Tie breaker question (lowest unused question)

b. Team with most runs in a given inning

c. Team with the most plate appearances in the game

13. Question Guide:

#1=Base hit, batter safe at 1st base

#2=Base hit, any runner advances one base

#3=Base hit, any runners advance one base

#4=Base hit, any runners advance one base

#5=Double, batter safe at 2nd base, any runners advance two bases

#6=Triple, batter safe at 3rd base, any runners advance three bases

#7=Home run, batter and all runners score

Boardgame Rules

1. Timer is started, the overhead slide cover is slid to reveal the first question and 4 possible answers: A, B, C or D.

2. Each player must answer each question, by flipping his/her answer card, to reveal the selected letter.

3. The teacher can use one of two scoring methods:

a. The team with the most correct responses wins; if the team at bat wins, it's a hit. If the team in the field wins, it's an out. An advantage arrow is used to break any ties, similar to the possession arrow in basketball. The transparency shows the hit value of each question (or refer to the guide at the end of these instructions).

b. Or, the selection spinner can be sued to decide which player's answer from each team will count (spin after all players have answered the question). The spinner contains numbers 1 through 7. If the arrow lands on #2, then count the answers from Blue team player 2 and Red team player 2. The player with the correct response wins. If the team at bat wins, it's a hit. If the team in the field wins, it's an out. An advantage arrow is used to break any ties, similar to the possession arrow in basketball. The transparency shows the hit value of each question. Each runner, who reaches home, scores a run.

4. Repeat steps 1 through 3 for each successive question. See instruction paragraph #6 for special plays. After the Blue team bats in the 1st inning, the Red team bats in the 1st. Then each team takes its turn in the 2nd and 3rd innings.

5. The inning continues until seven batters have batted or three outs are recorded, whichever comes first.

6. Special plays—each special play is listed below. The arrow does not decide ties. Rule of order is: i. Pick off; ii. Steal; iii. Intentional walk; iv. Pinch hit; v. Pitching change; vi. Hit and run; vii. Sacrifice bunt; viii. Sacrifice fly; and ix. Double play.

a. Steal—an extra question, not a time at bat—limit two per team. With a runner on 1st base and no runner on 2nd base, the team at bat can try to steal 2nd base. With a runner on 2nd base and no runner on 3rd base, the team at bat can try to steal 3rd base. If the team at bat calls a steal attempt, the special play transparency is used, with cover. The timer is set and the teacher reveals the first unanswered question on the card. The rules in paragraph #3 apply (except for tie breaker). If the team at bat wins, the runner is safe at second. If the defense wins, he is out. Ties go to the runner. After the special play, the teacher returns to the inning questions and continues with the next question in sequence.

b. Hit and run—counts as a time at bat—limit one per team. With at least one runner on base, the offense can try a hit and run to advance any runners two bases on a “single value” question. The special play transparency is used, with cover. The teacher sets the timer and reveals the first unanswered question on the card. The rules in paragraph #3 apply (except for tie breaker). If the team at bat wins, the batter is safe at 1st and runners advance two bases. If the defense wins, the batter is out and the runners do not advance. Ties go to the offense.

c. Sacrifice fly—counts as a time at bat—limit one per team. With a runner on 3rd base and less than two outs, the offense can try a sacrifice fly to score the runner on 3rd. The special play transparency is used, with cover. The teacher sets the timer and reveals the first unanswered question on the card. The rules in paragraph #3 apply (except for tie breaker). The batter is always out but, if the team at bat wins, the runner is safe at home. If the defense wins, he is out. Ties go to the runner.

d. Sacrifice bunt—counts as a time at bat—limit one per team. Similar to the sacrifice fly. With a runner on 1st or 2nd base and less than two outs, the offense can try a sacrifice bunt to advance the runner to the next base or avoid a double play attempt by the defense. Use the special play transparency, with cover. The special play transparency is used, with cover. The teacher sets the timer and reveals the first unanswered question on the card. The rules in paragraph #3 apply (except for tie breaker). The batter is always out but, if the team at bat wins, the runners advance one base. If the defense wins, he is out. Ties go to the runner. The offense cannot score a run via the sacrifice bunt.

e. Pinch-hit—counts as a time at bat—limit one per team. Once the question is revealed, the offense can elect to pinch hit to change questions. The new question will be the same value as the replaced question. The special play transparency is used, with cover. The teacher sets the timer and reveals the first unanswered question on the card. The rules in paragraph #3 apply (except for tie breaker). If the team at bat wins, the batter is safe at the base designated by the question value. If the defense wins, the batter is out. Ties go to the batter.

f. Pickoff—an extra question, not a time at bat—limit two per team. With a runner on 1st base, the team in the field can try to pickoff the runner on 1st base. If the team in the field attempts a pickoff. The special play transparency is used, with cover. The teacher sets the timer and reveals the first unanswered question on the card. The rules in paragraph #3 apply (except for tie breaker). If the team in the field wins, the runner is out. If the offense wins, he is safe at 1st base. Ties go to the defense. After the special play, return to the inning questions and continue with the next question in sequence.

g. Double play—counts as a time at bat, in place of question #2, #3, #4 or#5—limit one per team. With a runner on 1st base the team in the field can try a double play. The special play transparency is used, with cover. The teacher sets the timer and reveals the first unanswered question on the card. The rules in paragraph #3 apply (except for tie breaker). If the team in the field wins, both the runner on 1st and batter are out and any other runners advance one base. If the offense wins, the batter is safe at 1st and all runners move up two bases. Ties go to the defense.

h. Intentional walk—counts as a time at bat—limit one per team. To offset the scoring potential of a single, double or triple question, the defense can opt for an intentional walk. The special play transparency is used, with cover. The teacher sets the timer and reveals the first unanswered question on the card. The rules in paragraph #3 apply (except for tie breaker). If the team in the field wins, the batter is safe at 1st and runners can only advanced by force. If the offense wins, the batter is safe at the base designated by the question number, that would have been asked, and all runners advance accordingly. Ties go to the defense. The intentional walk cannot be used to end an inning (in place of a #7 question).

i. Pitching change—applies to one batter only—limit two per team. To stop an offense “on a roll”, the defense can elect a pitching change. The special play transparency is used, with cover. The teacher sets the timer and reveals the first unanswered question on the card. The rules in paragraph #3 apply (except for tie breaker). If the team in the field wins, the batter is out and runners do not advance. If the offense wins, the batter is safe at the base designated by the question and all runners advance accordingly. Ties go to the defense. After this batter, the regular game rules apply.

j. The Closer, a special pitching change—applies to the first three batters—limit one per team (counts as a pitching change). To close a game and seal the win, the defense can elect to bring in the closer. The special play transparency is used, with cover. The teacher sets the timer and reveals the first unanswered question on the card. The rules in paragraph #3 apply (except for tie breaker). If the team in the field wins, the batter is out and runners do not advance. If the offense wins, the batter is safe at the base designated by the question number, that would have been asked, and all runners advance accordingly. Ties go to the defense. After the third batter, the regular game rules apply.

### Television Game Show

In a further embodiment the competitive framework described above is applied to a television game show format. The television program is designed to be a mathematics study aid, designed to increase the players' and the viewers' math skills. In an embodiment of the television program, two high schools compete against each other, in a three-inning game, using a series of seven questions for each team; each inning, each question, progressively harder, each in compliment with the math syllabus for the competitors. The premise is for the students to answer the questions correctly, make hits and score runs.

1. The television game show is played with 5 players on each of two teams, a Blue team, and a Red team. Each player has a number going left to right; Blue team 1, 2, 3, 4, and 5 and Red team 1, 2, 3, 4, and 5. One player from each team is elected captain prior to airtime.

2. Each player has four answer buttons, A, B, C and D. The captain of each team also has the additional special play buttons.

3. Players must all be enrolled in the same grade or lower. Questions are based on the applicable grade's math curriculum and standardized tests.

4. Each team gets its time at bat and in the field each inning. In other words, each team will answer at least two sets of inning 1 questions, two sets of inning 2 questions and two sets of inning 3 questions.

5. Each team captain will get a 5 second decision time to lock in special plays. If no decision is made, the default is to “hit away”. Each player gets 15 seconds to lock in an answer.

6. The Blue team bats first and the Red team is in the field first. A coin flip at airtime decides home and away teams.

7. Each team bats in each inning (the Red team has “last bats”). The team at bat tries to get hits and score runs, while the team in the field tries to get them out, by correctly answering the math questions.

8. The team with the most runs scored, at the end of 3 innings, wins the game. In case of a tie score, winners are decided by tie breakers: a. Tie breaker question (highest unused question); b. Team with most runs in a given inning; c. Team with the most plate appearances in the game.

### Game Show Rules

1. Each team's captain optionally selects special plays, using the special play buttons.

2. Each player must answer each question, by pressing the applicable answer button, to reveal the selected response.

3. The team with the most correct responses wins; if the team at bat wins, it's a hit. If the team in the field wins, it's an out. A momentum arrow is used to break any ties, similar to the possession arrow in basketball. Each runner, who reaches home, scores a run.

4. After the Blue team bats in the 1st inning, the Red team bats in the 1st. Then each team takes a turn in the 2nd and 3rd innings.

5. The inning, for each team, continues until seven batters have batted or three outs are recorded, whichever comes first.

6. The “hit” value for each question is as follows:

#1=Base hit, batter safe at 1st base

#2=Base hit, any runner advances one base

#3=Base hit, any runners advance one base

#4=Base hit, any runners advance one base

#5=Double, batter safe at 2nd base, any runners advance two bases

#6=Triple, batter safe at 3rd base, any runners advance three bases

#7=Home run, batter and all runners score

7. Special plays—each special play is listed below. The arrow does not decide ties.

a. Rule of order is:

i. Pick off

ii. Intentional walk

iii. Steal

iv. Pitching change

v. Pinch Hit

vi. Sacrifice bunt

vii. Sacrifice fly, Double play, Play at the Plate

viii. Hit and run

b. When a special play is called the rules below apply. The momentum arrow is not used. The momentum goes to the team opting the special play. Should both teams opt a special play the rule of order decides which is in play. In this case, the special play with more weight is used, the other is not and that play can be used again on a later question. N.B., the sacrifice fly, double play and play at the plate all carry the same weight and both (sacrifice fly and double play or play at the plate) are counted as used. If the offense elects to try a sacrifice fly and the defense elects either the double play or the play at the plate on the same question, the result is dictated by the team that wins the question. If the offense wins, the sacrifice is good and the rules for sacrifice apply. If the defense wins, the rules for a successful double play or force at home apply.

c. Steal—an extra question, not a time at bat—limit two per team. With a runner on 1st base and no runner on 2nd base, the team at bat can try to steal 2nd base. With a runner on 2nd base and no runner on 3rd base, the team at bat can try to steal 3rd base. If the team at bat calls a steal attempt, they must win a question equal in level to the base they wish to steal: #5 level to steal 2nd, #6 to steal 3rd. Stealing home is not allowed. Runs can only be scored by batting. If the team at bat wins, the runner is safe. If the defense wins, the batter is out. Ties go to the runner. After the special play, return to the inning questions and continue with the next question in sequence.

d. Hit and run—counts as a time at bat—limit one per team. With at least one runner on base, the offense can try a hit and run to advance any runners two bases on a “single” valued question. The team at bat must win a question that is one level higher than normal, a #3 question in place of #2, or a #4 question in place of #3. If the team at bat wins, the batter is safe at 1st and runners advance two bases. If the defense wins, the batter is out and the runners do not advance. Ties go to the offense.

e. Sacrifice fly—counts as a time at bat—limit two per team. With a runner on 3rd base and less than two outs, the offense can try a sacrifice fly to score the runner on 3rd. The offense must win a #4 question. The batter is always out but, if the team at bat wins, the runner is safe at home. If the defense wins, the runner remains at 3rd. Ties go to the offense.

f. Sacrifice bunt—counts as a time at bat—limit one per team. Similar to the sacrifice fly. With a runner on 1st or 2nd base and less than two outs, the offense can try a sacrifice bunt to advance the runner to the next base or avoid a double play attempt by the defense. The batters must win a #3 question. The batter is always out but, if the team at bat wins, the runners advance one base. If the defense wins, the batter is out, and the runners do not advance. Ties go to the offense. The offense cannot score a run via the sacrifice bunt. In other words, you cannot use the sacrifice bunt with bases loaded.

g. Pinch-hit—counts as a time at bat—limit one per team. Once the question is revealed, the offense can elect to pinch hit to change questions. The new question will be the same value as the replaced question. If the team at bat wins, the batter is safe at the base designated by the question value. If the defense wins, the batter is out. Ties go to the offense.

h. Pickoff—an extra question, not a time at bat—limit one per team. With a runner on 1st base, the team in the field can try to pickoff the runner on 1st base. If the defense attempts a pickoff, they must win a question equal in level to the next base: #5 question to pickoff a runner on 1st, #6 to pickoff a runner on 2nd. If the team in the field wins, the runner is out. If the offense wins, he is safe at the current base. Ties go to the defense. After the special play, return to the inning questions and continue with the next question in sequence.

i. Double play—counts as a time at bat—limit two per team. With a runner on 1st base the team in the field can try a double play. To attempt a double play, the defense must win a #5 level question or higher, depending on the question “due up”. If the team in the field wins, both the runner on 1st and batter are out. Any other runners advance one base. If the offense wins, the batter is safe at 1st and all runners move up two bases. Ties go to the defense. In lieu of the Double Play, if the situation presents itself the team in the field can attempt a Play at the Plate.

j. Play at the Plate—counts as a time at bat—limit two per team. With a runner on 3rd base the team in the field can elect to try to get the runner out at home. To attempt this, the defense must win a #5 level question or higher, depending on the question “due up”. If the team in the field wins, the runner on 3rd is out and therefore cannot score. Any other runners advance one base. If the offense wins, the runner is safe at home, the batter is safe at 1st and all runners move up one base. Ties go to the defense. N.B., the defense gets two opportunities total between the Double Play and the Play at the Plate. They can attempt two double plays or two plays at the plate or one of each.

k. Intentional walk—counts as a time at bat—limit one per team. To offset the scoring potential of a single, double or triple question, the defense can opt for an intentional walk. The defense must win a #4 question. If the team in the field wins, the batter is safe at 1st and runners can only advanced by force. If the offense wins, the batter is safe at the base designated by the question number, that would have been asked (#4, #5 or #6), and all runners advance accordingly. Ties go to the defense. You cannot use the intentional walk to end an inning (in place of a #7 question).

1. Pitching change—applies to one batter only—limit two per team. To stop an offense “on a roll”, the defense can elect a pitching change. The new question will be the same value as the replaced question. If the team in the field wins, the batter is out and runners do not advance. If the offense wins, the batter is safe at the base designated by the question and all runners advance accordingly. Ties go to the defense. After this batter, the regular game rules apply.

While the invention has been described in detail and with reference to specific examples thereof, it will be apparent to one skilled in the art that various changes and modifications can be made therein without departing from the spirit and scope thereof.

What is claimed is:

1. A method of practicing educational exercises comprising:
posing at least one question to a student from an existing list of questions having defined answers;
providing a competitive framework based on a sport in which said student's answers to said questions enable scoring or defensive opportunities in said sport;
advancing play in said competitive framework based on whether said student's answer to said at least one question is correct or incorrect.

2. The method of claim 1 including the additional step of establishing competitive play in said sport-based framework between a plurality of students.

3. The method of claim 1 wherein said sport is baseball.

4. The method of claim 1 wherein said questions are posed and answered on a computer.

5. The method of claim 1 wherein said questions are displayed to a classroom on a large display means.

6. The method of claim 2, wherein said competitive play is broadcast on a television program.

7. The method of claim 2, wherein said competitive framework is performed by competing students on a plurality of computers, wherein said computers are linked.

8. The method of claim 1 further comprising:
establishing a question and answer database; and
storing responses to questions posed to said students in a student statistics database; wherein said question posed is selected by an instructor from said question and answer database.

9. The method of claim 8, further comprising providing a server computer that stores information for executing a computer program to provide said competitive framework, pose said questions and store student statistics.

10. A system for providing competitive learning exercises to a plurality of students, comprising:
a host computer having a learning exercise program, a student statistics database and a question and answer database;
a plurality of remote computers having a data connection to said host computer; wherein the students access the learning exercise program from said remote computers and answer questions posed by said program running on said host computer and
wherein said host computer program simulates competitive play in a sports game based on the students' responses to said questions and
wherein said host computer program allows students to select from a plurality of game strategy options and
wherein said questions have a difficulty level that is related to said game strategy options.

11. The system of claim 10, wherein said students' answers to said questions are stored in said student statistics database.

12. The system of claim 10, wherein said remote computers provide teacher access to said student statistics database.

13. The system of claim 10, wherein said learning access program displays images of actual sporting events during said competitive play.

14. The system of claim 10, wherein said learning access program produces simulated audio background related to said sports game on said remote computers.
